(19) United States
(12) Patent Application Publication
(10) Pub. No.: US 2012/0312679 A1
(43) Pub. Date: Dec. 13, 2012

(54) Distilled Water Machine

(75) Inventor: Chih-Hsiu Liu, New Taipei City (TW)

(73) Assignee: NENG BAO KANG ENTERPRISE CORPORATION, New Taipei City (TW)

(21) Appl. No.: 13/348,078

(22) Filed: Jan. 11, 2012

(30) Foreign Application Priority Data
Jun. 10, 2011 (TW) 100120269

(51) Int. Cl. B01D 3/02

(52) U.S. Cl. 202/176

(57) ABSTRACT

A kind of distilled water machine which can be directly and easily placed on common water dispenser to replace commercial available mineral water bucket. It is integrally designed as water bucket shape used on water dispenser, including cooling section, heating section, and water storage section set in turn from top to bottom inside the shell. The heating section is equipped with a heating element to connect with control circuit. Water becomes vapor through the heating of this heating section, and the vapor will flow into the cooling section for cooling and finally flow into the water storage section. A distilled water outlet is set at the bottom of the water storage section. This invention adopts a one-key switch control to realize convenient operation, high safety as well as energy-saving effect.

### CROSS-REFERENCE TO RELATED APPLICATION

This application claims the benefit of priority to Taiwan Patent Application No. 100120269, filed on Jun. 10, 2011, in the Taiwan Intellectual Property Office of the Republic of China, the disclosure of which is incorporated herein in its entirety by reference.

### BACKGROUND OF THE INVENTION

1. Field of the Invention

This invention claims a distilled water machine, especially the one used on water dispenser.

2. Description of the Related Art

Following problems exist in current distilled water machine:

1. The current distilled water machine is complex in structure which is mostly used in industry or mechanical treatment and seldom for home-use.

2. For current household distilled water machine, distilled water made by it will be completely stored in external connected container which may easily result in secondary pollution.

### SUMMARY OF THE INVENTION

This invention aims to provide a distilled water machine with simple structure and unique design to effectively solve the above mentioned problems existing in current technology.

The problems can be solved by this invention through following technical solutions:

A distilled water machine, which is integrally designed as water bucket shape used on water dispenser, comprises cooling section, heating section, and water storage section set in turn from top to bottom inside the shell. The mentioned heating section is equipped with a heating element to connect with the control circuit. Water becomes vapor through the heating of this heating section, and the vapor will flow into the cooling section for cooling and finally flow into the water storage section. A distilled water outlet is set at the bottom of the water storage section.

As the preferred embodiment of this invention, the inside of the mentioned heating section is equipped with a heating tank in which a primary heat insulation cylinder is set, and there's a conical heat insulation cylinder (outlet upward) in the primary heat insulation cylinder. The heating element connected with and controlled by the control circuit is located in the conical heat insulation cylinder. The control circuit is controlled by a temperature detect switch and an electronic float switch. In addition, the above mentioned heating tank, primary heat insulation cylinder and conical heat insulation cylinder are connected with each other through holes at the bottom thereof.

As the preferred embodiment of this invention, the cooling device comprises a cooling coil which is connected with outlet of the conical heat insulation cylinder, the other end of the cooling coil is connected with water pipe through a pipe fitting, and distilled water in the water pipe flows into the mentioned water storage section after flowing through a filtering device; it further comprises a fan located at the top end of the cooling coil and fixed in a top cover.

As the preferred embodiment of this invention, the distilled water outlet is connected with a mechanical float switch through a fitting.

As the preferred embodiment of this invention, the filtering device adopts a filter cartridge in which activated carbon layer, tourmaline stone ball layer and medical stone layer are set in turn.

As the preferred embodiment of this invention, the cooling section is equipped with an outer wind scooper, an inner wind scooper and a lower gas collection seat below the inner wind scooper. The mentioned cooling coil is located on the inner wind scooper and the lower gas collection seat leads the vapor from heating section to the cooling coil.

As the preferred embodiment of this invention, there are gasket rings between the heating tank, primary heat insulation cylinder, conical heat insulation cylinder and lower gas collection seat.

As the preferred embodiment of this invention, there is a groove at the bottom of the heating tank.

As the preferred embodiment of this invention, the mentioned top cover is in arc shape.

As the preferred embodiment of this invention, there are handle holes on the shells of heating section and cooling section.

Due to the above technical solutions, the distilled water machine in this invention adopts a design of two heat insulation cylinders and one heating tank to reach effective energy-saving effect; the use of float switch facilitates a simple operation and proper safety; the adoption of three-level filtration facilitates a good filtering effect and can produce purer and better alkalescent micro-clustered distilled water after filtering.

### BRIEF DESCRIPTION OF THE DRAWINGS

FIG. 1 is the structure diagram for a kind of distilled water machine in this invention.

### DETAILED DESCRIPTION OF THE PREFERRED EMBODIMENTS

Further description is made in accordance with the attached figure and specific embodiments:

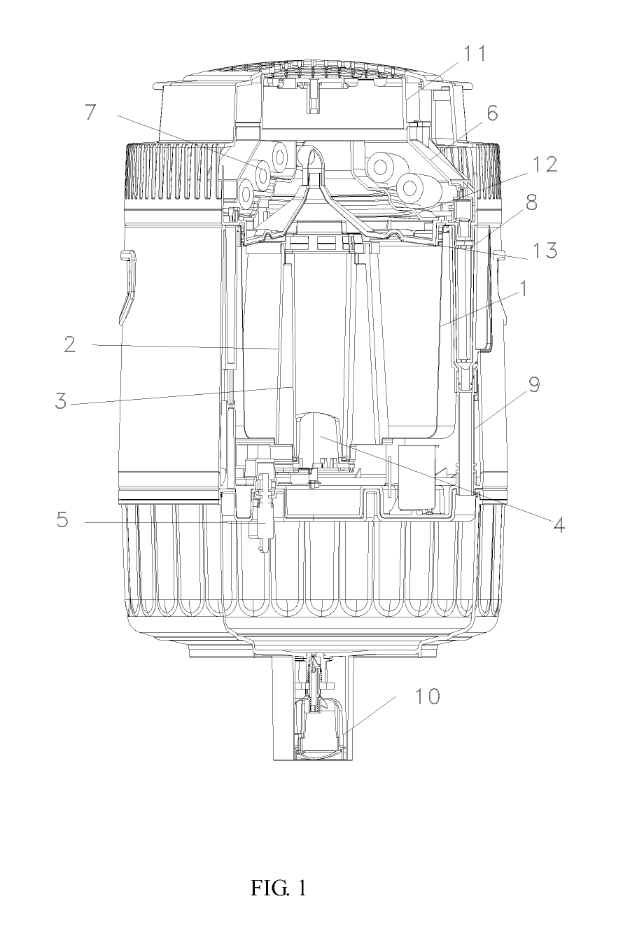

As shown in FIG. 1, a kind of distilled water machine can be directly and easily placed on common water dispenser to replace commercial available mineral water bucket. It is integrally designed as water bucket shape used on water dispenser, and of course it can be any necessary shapes such as cylindrical, square column shape and triangular column shape etc., including cooling section, heating section, and water storage section set in turn from top to bottom inside the shell. The heating section is equipped with a heating element to connect with control circuit. Water becomes vapor through heating of this heating section and the vapor will flow into the cooling section for cooling and finally flow into the water storage section. A distilled water outlet is set at the bottom of the water storage section.

In the embodiment, there's a heating tank 1 in the heating section, a primary heat insulation cylinder 2 in the heating tank 1, and a conical heat insulation cylinder 3 (outlet upward) in the primary heat insulation cylinder 2. The heating element connected with and controlled by the control circuit is located in the conical heat insulation cylinder 3. The control circuit is controlled by a temperature detect switch and an electronic float switch. In addition, the above mentioned heating tank 1, primary heat insulation cylinder 2 and conical heat insulation cylinder 3 are connected with each other through holes at the bottom thereof. The cooling section is equipped with an outer wind scooper 6, an inner wind scooper 12, and a lower gas collection seat 13 in the shell. A cooling coil 7 connected with the outlet of the conical heat insulation cylinder 3 is located on the inner wind scooper 12, and the lower gas collection seat 13 leads the vapor from heating section to the cooling coil 7. The other end of the cooling coil 7 is connected with water pipe 9 through a pipe fitting, and distilled water in the water pipe flows into the water storage section after flowing through a filtering device 8. There's a gas vent on the fitting cover to discharge chlorine gas out of water. There's also a fan 11 at the cooling section located at the top end of the cooling coil and fixed in a top cover. The distilled lower part of the water storage section is connected with a mechanical float switch 10 through a fitting. In order to better ensure heat and vapor without loss, gasket rings are equipped between heating tank 1, primary heat insulation cylinder 2, conical heat insulation cylinder 3, and lower gas collection seat 13. In addition, this invention adopts a design of primary heat insulation cylinder 2 and conical heat insulation cylinder 3 equipped inside the heating tank 1 to reduce heat exchange during heating so as to ensure that little quantity of water can quickly become vapor.

In the embodiment, the filtering device adopts a filter cartridge in which activated carbon layer, tourmaline stone ball layer and medical stone layer are set in turn. The main purpose of activated carbon layer is to absorb harmful gases, filter indissoluble substances, and remove peculiar smells; Tourmaline is a kind of crystal type mineral with pyroelectricity and piezoelectricity which can durably release far IR negative ions with bioelectricity and rich mineral nutritive elements to inhibit bacterial reproduction; Medical stone is an ideal water purificant and modifying agent used to effectively absorb and remove heavy metals such as lead, cadmium, mercury, arsenium, hexavalent chrome etc. from water. Water after being immerged with medical stone will become clean activated mineral water due to ion exchange and absorption of harmful ingredient and various bacteria colonies caused by water pollution. Meanwhile, various minerals and trace elements that are beneficial to human body will be released. For this kind of water, long term drinking can be helpful in removing harmful substances accumulated in human body, adjusting metabolism, and promoting blood circulation. It also has functions such as promoting urination, promoting digestion, and protecting liver etc., and is also referred to as “Cell Detergent”. It is helpful in healing hypertension, gastrelcosis, chronic gastritis, nephritis, hepatitis, urinary disease, melliturid, heart disease, premature beat, and tracheitis etc. After a three-layer filtration, the distilled water will be cleaner, purer and better in taste which is beneficial to human body.

In the embodiment, the top cover is in arc shape to effectively avoid blocking the air outlet so as to avoid influencing heat output effect; the handle holes on the shells of heating section and cooling section can facilitate operation.

In the embodiment, there is a groove at the bottom of the heating tank 1. Such a design can reserve a small amount of water that contains harmful substances such as impurities or heavy metals etc. and prevent it from gasification.

The whole equipment in this invention is controlled by a switch to automatically control operation process and facilitate operation. The use process of this invention is as follows:

1. Place the distilled water machine on a water dispenser and remove the mentioned cooling section;

2. Add water in the heating tank 1 and the water amount shall not exceed the upper limit of water addition;

3. Place the primary heat insulation cylinder 2, and place the conical heat insulation cylinder 3, and cover the cooling section;

4. Insert power plug and press power switch to start the distilled water machine;

5. When water level in the water bucket of water storage section reaches the upper limit, the electronic float switch will start working and cut off the power supply;

6. When the water level in the water bucket decreases or there's no water in it, the machine will not work until user cuts off the power switch, adds water to the heating tank, and reconnects the power switch.

7. When water in the heating tank 1 is dried to none, the temperature detect switch in the distilled water machine will start working and cut off power supply, and the distilled water machine will stop working. The distilled water machine will be restarted after user adds water in it and reconnects the power supply.

What is claimed is:

1. A distilled water machine which is integrally designed as water bucket shape used on water dispenser, including a cooling section, a heating section, and a water storage section set in turn from top to bottom inside the shell, wherein the heating section is equipped with a heating element to connect with a control circuit; water becomes vapor through the heating of this heating section, and the vapor will flow into a cooling device disposed in the cooling section for cooling and finally flow into the water storage section; and a distilled water outlet is set at the bottom of the water storage section.

2. The distilled water machine according to claim 1, wherein the heating section is set with a heating tank inside, a primary heat insulation cylinder is set in the heating tank, and a conical heat insulation cylinder with outlet upward is set in the primary heat insulation cylinder; the heating element connected with and controlled by the control circuit is located in the conical heat insulation cylinder, and the control circuit is controlled by a temperature detect switch and an electronic float switch; in addition, the above mentioned heating tank, primary heat insulation cylinder and conical heat insulation cylinder are connected with each other through holes at the bottom thereof.

3. The distilled water machine according to claim 2, wherein the cooling device has a cooling coil which is connected with an outlet of the conical heat insulation cylinder, the other end of the cooling coil is connected with a water pipe through a pipe fitting, and distilled water in the water pipe flows into the mentioned water storage section after flowing through a filtering device; further comprising a fan located at the top end of the cooling coil and fixed in a top cover.

4. The distilled water machine according to claim 3, wherein the distilled water outlet is connected with a mechanical float switch through a fitting.

5. The distilled water machine according to claim 3, wherein the filtering device adopts a filter cartridge in which activated carbon layer, tourmaline stone ball layer and medical stone layer are set in turn.

6. The distilled water machine according to claim 3, wherein the cooling section is equipped with an outer wind scooper, an inner wind scooper, and a lower gas collection seat below the inner wind scooper; the mentioned cooling coil is located on the inner wind scooper, and the lower gas collection seat leads the vapor from heating section to the cooling coil.

7. The distilled water machine according to claim 6, wherein gasket rings are set between the heating tank, the primary heat insulation cylinder, the conical heat insulation cylinder and the lower gas collection seat.

8. The distilled water machine according to claim 2, wherein a groove is set at the bottom of heating tank.

9. The distilled water machine according to claim 3, wherein the top cover is in arc shape.

10. The distilled water machine according to claim 1, wherein handle holes are set on the shells of heating section and cooling section.
